(19) United States
(12) Patent Application Publication
(10) Pub. No.: US 2006/0042283 A1
(43) Pub. Date: Mar. 2, 2006

(54) Air-conditioner and controlling method therefor

(75) Inventors: Yoon-Jei Hwang, Seoul (KR); Seung-Youp Hyun, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/028,675

(22) Filed: Jan. 5, 2005

(30) Foreign Application Priority Data
Aug. 25, 2004 (KR) 67169/2004

(51) Int. Cl. G05D 23/00; F25B 49/00; F25D 17/00; F25B 1/00

(52) U.S. Cl. 62/229; 62/178; 236/51

(57) ABSTRACT

Disclosed are an air-conditioner which does not require a communication line, which connects an indoor unit to a thermostat, to mount in an indoor wall and a user can easily move the thermostat as occasion demands, and a controlling method therefor. The air-conditioner according to the present invention comprises: the thermostat for converting a control signal to control an indoor fan and a compressor of an outdoor unit in the air-conditioner into a radio frequency (RF) signal, and transmitting the converted RF signal; and the indoor unit for receiving the RF signal, and generating the control signal to control the indoor fan and the compressor of the outdoor unit based on the received RF signal.

### BACKGROUND OF THE INVENTION

1. Field of the Invention

The present invention relates to an air-conditioner, and particularly, to a method for controlling an air-conditioner.

2. Description of the Prior Art

In general, an air-conditioner, particularly, a unitary air-conditioner is a type of a central cooling and heating system which is used in a factory, an office, a hotel, a house, or the like, and provides cold blast or hot blast to each indoor through a duct installed in a building.

The unitary air-conditioner independently supplies cold blast or hot blast into a zone (e.g., an inner room) where requires for a cooling or a heating through a zone controller installed between ducts placed in the building.

Hereinafter, a construction of a unitary air-conditioner based on the conventional art will be described with reference to FIGS. 1 and 2.

FIGS. 1 and 2 are a block diagram and a mimetic diagram showing the construction of the unitary air-conditioner based on the Prior art.

Referring to FIG. 1, the unitary air-conditioner based on the conventional art is comprised of: an outdoor unit 1 installed to be fixed on the outside of a building (e.g., a second-story house (Z2)); an indoor unit 2 connected to the outdoor unit 1 through a refrigerant pipe and mounted to be fixed in a basement or on a wall of the building, for supplying cold or hot blast in the building; an inlet duct 3 and an outlet duct 4 connected to an inlet port and outlet port of the indoor unit 2, respectively, and installed on walls of each story of the building to be separated; and zone controllers 5A˜5D installed between the inlet duct 3 and the outlet duct 4 and distinguishing an inflow air and an outflow air transferred via the inlet duct 3 and the outlet 4.

Referring to FIG. 2, the outdoor unit 1 is comprised of: a compressor 1A compressing refrigerant gas; a first heat exchanger 1B connected to the compressor 1A through the refrigerant pipe, and condensing the refrigerant gas when the unitary air-conditioner is in a cooling mode and absorbing latent heat when the unitary air-conditioner is in a heating mode; an expansion valve 1C decreasing a pressure of the refrigerant gas or expanding the refrigerant gas; and an outdoor fan (not shown) supplying an external air to the first heat exchanger 1B to raise a heat exchanging efficiency of the first heat exchanger 1B.

The indoor unit 2 is comprised of: a second heat exchanger 2A connected to the first heat exchanger 1B and the expansion valve 1C; and an indoor fan (not shown) placed at the second heat exchanger 2A, for inducing cool blast or hot blast to the inlet duct 3.

The inlet duct 3 and the outlet duct 4 are connected to the inlet port and the outlet port of the indoor unit 2 and mounted on corresponding zones (e.g., a first floor (Z1), a second floor (Z2), etc). Also, the inlet duct 3 and the outlet duct 4 respectively have a discharge opening 3A supplying cold blast or hot blast to a corresponding zone and a suction opening 4A sucking indoor air to circulate the indoor air.

In general, the zone controllers 5A˜5D are valves mounted on the inlet duct 3 and the outlet duct 4 installed in corresponding zones (e.g., ZI and Z2) in order to supply cold blast or hot blast to the corresponding zones (Z1 and Z2). That is, the zone controller 5A˜5D are electrically connected to a controller (not shown) of the unitary air-conditioner, and the controller detects a temperature or a humidity of corresponding zones, compares the detected value of the temperature or the humidity with a predetermined value, and controls the zone controllers 5A˜5D to be turned on/off according to the compared result.

Hereinafter, it will be explained of problems of the unitary air-conditioner based on the conventional art with reference to FIG. 3.

FIG. 3 is a diagram showing a schematic construction of the unitary air-conditioner based on the Prior art.

Referring to FIG. 3, the unitary air-conditioner is comprised of: an outdoor unit (not shown) for controlling a compressor (not shown) based on a control signal; an indoor fan (not shown) being rotated depending on the control signal; a thermostat 10 installed indoors to be fixed therein, for generating the control signal to control the indoor fan and the compressor of the outdoor unit on the basis of the indoor temperature and a temperature predetermined by a user; and an indoor unit 12 connected to the thermostat 10 by wire through a communication line 11, receiving the control signal through the communication line 11 and outputting the received control signal to the indoor fan and the outdoor unit. Here, the control signal is a signal to control the compressor of the outdoor unit to be turned on/off as well as to control the indoor fan of the indoor unit 12 to be turned on/off, in order to maintain the indoor temperature in the temperature predetermined by the user.

However, in the conventional art, the communication line 11 connecting the indoor unit 12 and the thermostat 10 of the air-conditioner is mounted in an indoor wall to be fixed, the user can not move the thermostat 10 in case of need.

Furthermore, it is also difficult for an installer to install the communication line 11 because the communication line 11 connecting the indoor unit 12 and the thermostat 10 of the air-conditioner of the conventional art should be mounted in the indoor wall.

On the other hand, the conventional air-conditioner is disclosed in U.S. Pat. No. 6,519,957 registered on 18th of Feb., 2003.

### SUMMARY OF THE INVENTION

Therefore, an object of the present invention is to provide an air-conditioner and a controlling method therefor by which a communication line to connect an indoor unit to a thermostat does not have to be mounted in an indoor wall and a user can easily move the thermostat as occasion demands by converting a control signal of the thermostat in the air-conditioner to a radio frequency (RF) signal and wirelessly transmitting the converted RF signal to the indoor unit of the air-conditioner.

To achieve these and other advantages and in accordance with the purpose of the present invention, as embodied and broadly described herein, there is provided an air-conditioner, comprising: a thermostat for converting a control signal for controlling an indoor fan and a compressor of an outdoor unit in the air-conditioner to a radio frequency (RF) signal and transmitting the converted RF signal; and an indoor unit for receiving the RF signal and generating the control signal for controlling the indoor fan and the compressor of the outdoor unit on the basis of the received RF signal.

According to another embodiment of the present invention, there is provided an air-conditioner, comprising: a thermostat for detecting an indoor temperature, generating a control signal for controlling an indoor fan and a compressor of an outdoor unit based on the detected indoor temperature and a temperature predetermined by a user, converting the generated control signal to a radio frequency (RF) signal, and then transmitting the RF signal; and an indoor unit for receiving the RF signal, generating a control signal for controlling the indoor fan and the compressor of the outdoor unit on the basis of the received RF signal, and then outputting the generated control signal to the indoor fan and the outdoor unit.

To achieve these and other advantages and in accordance with the purpose of the present invention, there is provided a method for controlling an air-conditioner, comprising the steps of: generating a control signal for controlling an indoor fan of an indoor unit and a compressor of an outdoor unit in the air-conditioner, depending on an indoor temperature and a temperature predetermined by user; converting the control signal to a radio frequency (RF) signal, and transmitting the converted RF signal to the indoor unit; and receiving the transmitted RF signal, and converting the received RF signal into the control signal for controlling the indoor fan and the compressor of the outdoor unit.

The thermostat of the air-conditioner in accordance with the present invention includes: a controller for comparing an indoor temperature with a temperature predetermined by a user and outputting a control signal for controlling an indoor fan and a compressor of an outdoor unit in the air-conditioner based on the compared result; and a radio frequency (RF) transmitter for converting the control signal from the controller to an RF signal, and transmitting the converted RF signal.

The indoor unit of the air-conditioner in accordance with the present invention includes: a radio frequency (RF) receiver for receiving an RF signal, thereafter converting the RF signal to a control signal for controlling an indoor fan and a compressor of an outdoor unit of the air-conditioner, and then outputting the converted control signal; and a controller for outputting the control signal outputted from the RF receiver to the indoor fan and the outdoor unit.

According to another embodiment of the present invention, the air-conditioner comprises: a thermostat generating a control signal on the basis of an indoor temperature and a temperature predetermined by a user; an indoor unit connected to the thermostat through a communication line; and an outdoor unit connected to the indoor unit, wherein the thermostat includes a radio frequency (RF) transmitter which converts the generated control signal to an RF signal and transmits the converted RF signal, and the indoor unit includes an RF receiver is which receives the RF signal and converts the received RF signal to the control signal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1 and 2 are a block diagram and a mimetic diagram showing a construction of a unitary air-conditioner based on the Prior art;

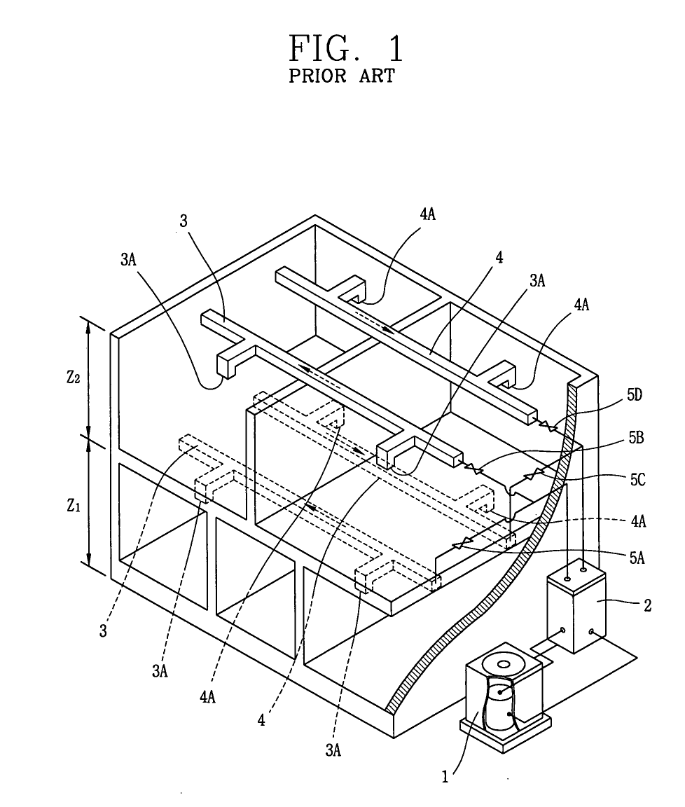

FIG. 3 is a schematic diagram showing a construction of the unitary air-conditioner based on the Prior art; and

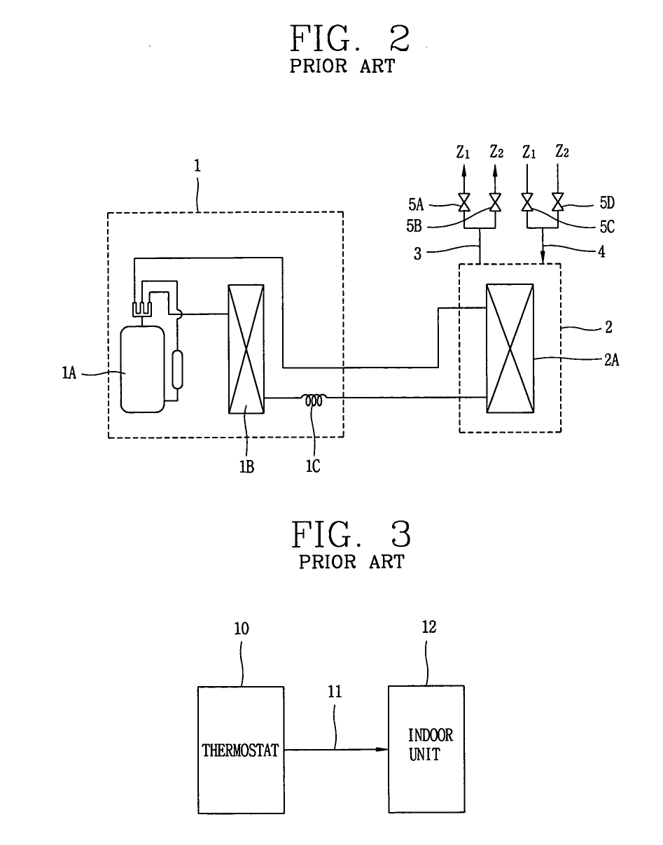

FIG. 4 is a block diagram showing a construction of an air-conditioner in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

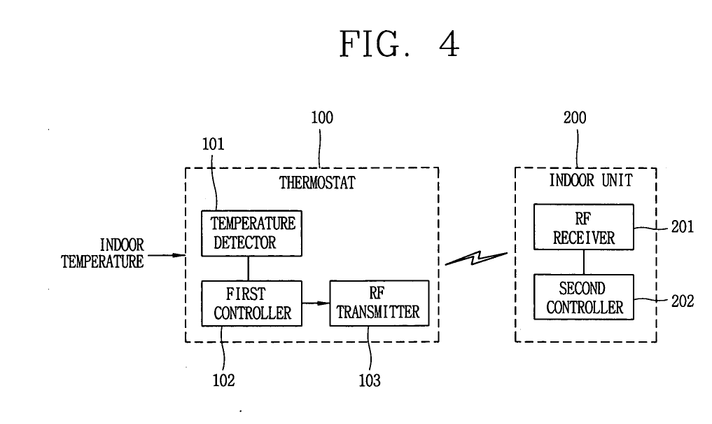

Hereinafter, it will be described with reference to FIG. 4 about a preferred embodiment for an air-conditioner in which a communication line for connecting an indoor unit and a thermostat is not required to be mounted in an indoor wall and a user can easily move the thermostat as occasion demands, by converting a control signal of a thermostat thereof to an radio frequency (RF) signal and wirelessly transmitting the converted RF signal to an indoor unit thereof.

FIG. 4 is a block diagram showing a construction of an air-conditioner in accordance with an embodiment of the present invention.

Referring to FIG. 4, the air-conditioner in accordance with an embodiment of the present invention is comprised of: an outdoor unit (not shown) driving a compressor based on a control signal; an indoor fan (not shown) rotated on the basis of the control signal; a thermostat 100 for detecting an indoor temperature, generating the control signal for controlling the indoor fan and the compressor of the outdoor unit on the basis of the detected indoor temperature and a temperature predetermined by a user, converting the control signal to a radio frequency (RF) signal, and then transmitting the RF signal; and an indoor unit 200 receiving the RF signal transmitted from the thermostat 100, generating the control signal for controlling the indoor fan and the compressor of the outdoor unit on the basis of the received RF signal, and then outputting the control signal to the indoor fan and the outdoor unit. Here, the control signal is a signal to control the compressor of the outdoor unit to be turned on/off as well as to control the indoor fan of the indoor unit 200 to be turned on/off, in order to maintain the indoor temperature in the temperature predetermined by the user.

The thermostat 100 is comprised of: a temperature detector 101 for detecting the indoor temperature; a first controller 102 for comparing the indoor temperature with the temperature predetermined by the user, and generating and outputting a control signal to operate the indoor fan and the compressor of the outdoor unit based on the compared result; and a radio frequency (RF) transmitter 103 for converting the control signal from the first controller 102 to an RF signal and then wirelessly transmitting the RF signal.

The indoor unit 200 is comprised of: a radio frequency (RF) receiver 201 for receiving the RF signal transmitted from the RF transmitter 103, and converting the received RF signal to the control signal for controlling the indoor fan and the compressor of the outdoor unit; and a second controller 202 for outputting the converted control signal to the indoor fan and the outdoor unit. Here, the first controller 102 and the second controller 202 can be embodied by a microcomputer.

An operation of the air-conditioner in accordance with the preferred embodiment of the present invention will be described in detail, hereinafter.

First, the thermostat 100 detects an indoor temperature, and generates a control signal for controlling the indoor fan and the compressor of the outdoor unit based on the detected indoor temperature and a temperature predetermined by a user. Thereafter, the thermostat 100 converts the control signal to an RF signal to transmit the converted RF signal to the indoor unit 200. For instance, the temperature detector 101 of the thermostat 100 detects the indoor temperature and applies the detected indoor temperature to the first controller 102. The first controller 102 then generates the control signal for controlling the indoor fan and the compressor of the outdoor unit to maintain the indoor temperature in the predetermined desired temperature, and applies the generated control signal to the RF transmitter 103. At this time, the RF transmitter 103 converts the control signal to the RF signal, thereafter transmitting the converted RF signal to the RF receiver 201 of the indoor unit 200.

Then, the indoor unit 200 converts the RF signal transmitted from the thermostat 100 to the control signal, and then outputs the converted control signal to the indoor fan and the outdoor unit. For instance, the RF receiver 201 of the indoor unit 200 receives the RF signal, and thereafter converts the RF signal to the control signal for controlling the indoor fan and the compressor of the outdoor unit. The converted control signal is then outputted to the second controller 202 of the indoor unit 200. The second controller 202 thereafter outputs the control signal to the indoor fan and the outdoor unit. At this time, the indoor fan is rotated based on the control signal, and the outdoor unit operates the compressor according to the control signal to vary a compression capacity of the compressor.

Therefore, in the air-conditioner of the present invention, the RF transmitter 103 is mounted in the thermostat 100 installed indoors, the control signal for varying a cooling efficiency or a heating efficiency is converted into the RF signal through the RF transmitter 103, and the RF signal is transmitted to the RF receiver 201 of the indoor unit 200.

As described above, the air-conditioner in accordance with the present invention does not require to mount the communication line connecting the indoor unit to the thermostat in the indoor wall and can allow the user to easily move the thermostat as occasion demands, by converting the control signal of the thermostat in the air-conditioner to the RF signal and wirelessly transmitting the converted RF signal to the indoor unit of the air-conditioner.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An air-conditioner, comprising:
a thermostat for converting a control signal to control an indoor fan and a compressor of an outdoor unit in the air-conditioner into a radio frequency (RF) signal, and transmitting the converted RF signal; and
an indoor unit for receiving the RF signal, and generating the control signal to control the indoor fan and the compressor of the outdoor unit on the basis of the received RF signal.

2. The air-conditioner of claim 1, wherein the thermostat comprises:
a first controller for outputting the control signal for controlling the indoor fan and the compressor of the outdoor unit on the basis of an indoor temperature and a temperature predetermined by a user; and
a radio frequency (RF) transmitter for converting the control signal from the first controller into the radio frequency (RF) signal, and transmitting the converted RF signal.

3. The air-conditioner of claim 2, wherein the indoor unit comprises:
a radio frequency (RF) receiver for receiving the RF signal transmitted from the RF transmitter and converting the RF signal into the control signal; and
a second controller for outputting the converted control signal to the indoor fan and the outdoor unit.

4. An air-conditioner, comprising:
a thermostat for detecting an indoor temperature, generating a control signal to control an indoor fan and a compressor of an outdoor unit based on the detected indoor temperature and a temperature predetermined by a user, converting the generated control signal into a radio frequency (RF) signal, and then transmitting the RF signal; and
an indoor unit for receiving the RF signal, then, generating the control signal to control the indoor fan and the compressor of the outdoor unit based on the received RF signal, and then outputting the generated control signal to the indoor fan and the outdoor unit.

5. The air-conditioner of claim 4, wherein the thermostat comprises:
a first controller for comparing the indoor temperature and the predetermined temperature and outputting the control signal to control the indoor fan and the compressor of the outdoor unit based on the compared result; and
a radio frequency (RF) transmitter for converting the control signal outputted from the first controller into the radio frequency (RF) signal, and transmitting the converted RF signal.

6. The air-conditioner of claim 5, wherein the indoor unit comprises:
a radio frequency (RF) receiver for receiving the RF signal transmitted from the RF transmitter, converting the RF signal into the control signal to control the indoor fan and the compressor of the outdoor unit, and then outputting the converted control signal; and
a second controller for outputting the control signal outputted from the RF receiver to the indoor fan and the outdoor unit.

7. A method for controlling an air-conditioner, comprising the steps of:
generating a control signal for controlling an indoor fan of an indoor unit and a compressor of an outdoor unit in an air-conditioner on the basis of an indoor temperature and a temperature predetermined by a user;
converting the control signal into a radio frequency (RF) signal, and transmitting the converted RF signal to the indoor unit; and
receiving the transmitted RF signal, and converting the RF signal into the control signal to control the indoor fan and the compressor of the outdoor unit.

8. A thermostat of an air-conditioner, comprising:
a controller for comparing an indoor temperature and a temperature predetermined by a user, and outputting a control signal to control an indoor fan and a compressor of an outdoor unit in an air-conditioner according to the compared result; and
a radio frequency (RF) transmitter for converting the control signal outputted from the controller into a radio frequency (RF) signal and transmitting the converted RF signal.

9. An indoor unit of an air-conditioner, comprising:
a radio frequency (RF) receiver for receiving a radio frequency (RF) signal, converting the RF signal into a control signal to control an indoor fan and a compressor of an outdoor unit in an air-conditioner, and then outputting the converted control signal; and
a controller for outputting the control signal from the RF receiver to the indoor fan and the outdoor unit.

10. An air-conditioner, comprising a thermostat for generating a control signal based on an indoor temperature and a temperature predetermined by a user, an indoor unit connected to the thermostat through a communication line, and an outdoor unit connected to the indoor unit,
wherein the thermostat includes a radio frequency (RF) transmitter for converting the generated control signal into a radio frequency (RF) signal and transmitting the converted RF signal, and
wherein the indoor unit includes a radio frequency (RF) receiver for receiving the RF signal and converting the received RF signal into the control signal.
